(19) United States
(12) Patent Application Publication
(10) Pub. No.: US 2008/0118043 A1
(43) Pub. Date: May 22, 2008

(54) Call Control Apparatus and Method for Controlling Call Control Apparatus

(75) Inventors: Yukio Kawaguchi, Kawasaki (JP); Chikazu Ueno, Kawasaki (JP); Masaaki Hosoda, Kawasaki (JP); Jun Kato, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 11/942,063

(22) Filed: Nov. 19, 2007

(30) Foreign Application Priority Data
Nov. 21, 2006 (JP) 2006-314743

(51) Int. Cl. H04M 11/00

(52) U.S. Cl. 379/93.14

(57) ABSTRACT

A call control method of a call control apparatus that establishes a call connection between an originating terminal and a receiving terminal in a network in which a plurality of call control apparatuses are provided is provided. The method includes detecting whether, in the call control apparatus, call connection processing is under congestion conditions, upon detecting that call connection processing is under congestion conditions, transferring, to another call control apparatus in the network, connection information for processing a call connection request from the originating terminal and sending, to the originating terminal, call connecting apparatus identification information with which the originating terminal establishes a call connection using the other call control apparatus, and upon detecting that call connection processing is not under congestion conditions and obtaining the connection information from the call control apparatus, establishing a call connection from the originating terminal included in the connection information.

### BACKGROUND OF THE INVENTION

1. Field of the Invention

The present invention relates to a call control apparatus that establishes a call connection using Internet Protocol (IP).

2. Description of the Related Art

One of the prior art documents related to call control apparatuses is Japanese Unexamined Patent Application Publication No. 2001-218241.

### SUMMARY

It is an object of the present invention to, even when a call control apparatus is congested, enable call connections from subscribers registered in the call control apparatus.

A call control method, according to a first aspect of the present invention, of a call control apparatus that establishes a call connection between an originating terminal and a receiving terminal in a network in which a plurality of call control apparatuses are provided is provided. The method includes detecting whether, in the call control apparatus, call connection processing is under congestion conditions, upon detecting that call connection processing is under congestion conditions, transferring, to another call control apparatus in the network, connection information for processing a call connection request from the originating terminal and sending, to the originating terminal, call connecting apparatus identification information with which the originating terminal establishes a call connection using the other call control apparatus, and upon detecting that call connection processing is not under congestion conditions and obtaining the connection information from the call control apparatus, establishing a call connection from the originating terminal included in the connection information.

A call control method, according to a second aspect of the present invention, of a call control apparatus that establishes a call connection between an originating terminal and a receiving terminal via a network in a case where the call control apparatus is congested is provided. The method includes transferring, to another call control apparatus that is not congested and is provided in the network, connection information for processing a call connection request from the originating terminal, and sending, to the originating terminal, call connecting apparatus identification information with which the originating terminal establishes a call connection using the other call control apparatus.

A call control method, according to a third aspect of the present invention, of a call control apparatus that establishes a call connection between an originating terminal and a receiving terminal via a network is provided. The method includes obtaining connection information for processing a call connection request from the originating terminal from another call control apparatus, provided in the network, in which call connection processing is under congestion conditions, and establishing a call connection from the originating terminal included in the connection information.

In the aforementioned call control methods, the connection information may be transferred by transmission of a command that can register the connection information in the call control apparatus, which is not congested, by the congested call control apparatus to the call control apparatus, which is not congested, and the connection information may be obtained by execution of the command by the call control apparatus, which is not congested.

In the aforementioned call control methods, the call connecting apparatus identification information may be sent using a call control communication unit, and the connection information may be sent using a communication unit other than the call control communication unit.

A call control apparatus, according to a fourth aspect of the present invention, that is controlled by a computer program and establishes a call connection between an originating terminal and a receiving terminal in a network in which a plurality of call control apparatuses are provided is provided. The computer program detects whether, in the call control apparatus, call connection processing is under congestion conditions, upon detecting that call connection processing is under congestion conditions, transfers, to another call control apparatus in the network, connection information for processing a call connection request from the originating terminal and sends, to the originating terminal, call connecting apparatus identification information with which the originating terminal establishes a call connection using the other call control apparatus, and upon detecting that call connection processing is not under congestion conditions and obtaining the connection information from the call control apparatus, establishes a call connection from the originating terminal included in the connection information.

In the aforementioned call control apparatus, the connection information may be transferred by transmission of a command that can register the connection information in the call control apparatus, which is not congested, by the congested call control apparatus to the call control apparatus, which is not congested, and the connection information may be obtained by execution of the command by the call control apparatus, which is not congested.

In the aforementioned call control apparatus, the call connecting apparatus identification information may be sent using a call control communication unit, and the connection information may be sent using a communication unit other than the call control communication unit.

In the present invention, an advantageous effect can be achieved in that, even when an SIP server becomes congested, subscribers registered in the SIP server can establish call connections.

Moreover, another advantageous effect can be achieved in that subscriber information is transferred using a subscriber information registration command when an SIP server becomes congested, and thus the traffic between SIP servers is less than that in a case where the subscriber information is transferred.

Moreover, yet another advantageous effect can be achieved in that subscriber information is transferred using a communication unit other than a communication unit that performs call control when an SIP server becomes congested, and thus subscriber information can be reliably transferred even when an SIP server is congested.

### BRIEF DESCRIPTION OF THE DRAWINGS

FIG. 1 is a hardware block diagram of an SIP server;

FIG. 2 is the layout of an SIP terminal database (DB);

FIG. 3 is the layout of a congestion DB;

FIG. 4 is the layout of an associate SIP server DB;

FIG. 5 is the layout of a subscriber DB;

FIG. 6 is a hardware block diagram of an SIP terminal;

FIG. 7 is the layout of an SIP server DB;

FIG. 8 is a sequence diagram of an embodiment of the present invention;

FIG. 9 is the layout of an SIP request (INVITE);

FIG. 10 is the layout of UDP (Simple Network Management Protocol (SNMP) (GetRequest));

FIG. 11 is the layout of UDP (SNMP (GetResponse));

FIG. 12 is the layout of UDP (a subscriber information registration command);

FIG. 13 is the layout of UDP (a response of the subscriber information registration command);

FIG. 14 is the layout of an SIP response (503);

FIG. 15 is the layout of UDP (the IP address of another SIP server); and

FIG. 16 is a schematic diagram of the embodiment of the present invention.

### DESCRIPTION OF THE PREFERRED EMBODIMENTS

Examples of signaling used in Voice over IP (VoIP) include Session Initiation Protocol (SIP) defined in, for example, Request For Comments (RFC) 3261 by the Internet Engineering Task Force (IETF). An IP telephone system in which SIP is used includes SIP terminals and an SIP server that support SIP.

In an IP telephone system in which SIP terminals and an SIP server are used, a call connection is established by the following procedure: An originating SIP terminal first sends an SIP request indicating a call connection request to an SIP server. The SIP request includes identification information for identifying a receiving SIP terminal. The SIP server relays the SIP request to the receiving SIP terminal using the identification information in the received SIP request. Then, the receiving SIP terminal sends an SIP response corresponding to the SIP request to the SIP server. The SIP server relays the received SIP response to the originating SIP terminal. Then, the originating SIP terminal and the receiving SIP terminal transport voice to each other without the intervention of the SIP server using Real-time Transport Protocol (RTP) defined in RFC 3550. Thus, the originating SIP terminal and the receiving SIP terminal become capable of talking to each other.

However, in a known SIP server, when the SIP server becomes congested, call regulation for regulating incoming calls is carried out to avoid system failure. In the call regulation, the SIP server does not relay an SIP request for a call connection request received from an originating SIP terminal of a subscriber registered in the SIP server to a receiving SIP terminal and returns an SIP response indicating that the SIP server is congested to the originating SIP terminal. Thus, SIP terminals of subscribers registered in a congested SIP server cannot establish a call connection until the congestion of the SIP server is cleared up.

An IP telephone system, in which SIP is used, for solving the aforementioned problem according to an embodiment will now be described with reference to the drawings.

### 1. The Outline of an Embodiment of the Present Invention

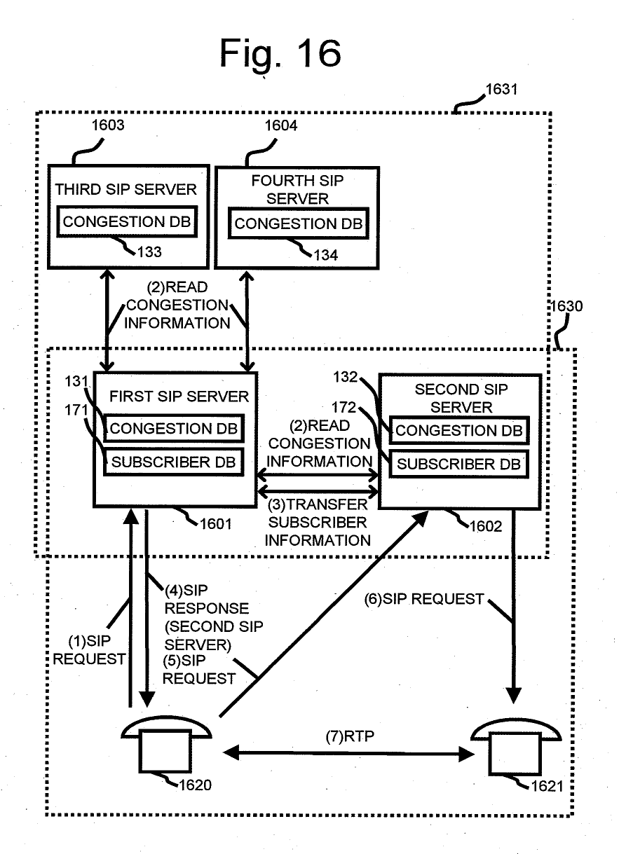

FIG. 16 is a schematic diagram of the present embodiment. The IP telephone system according to the present embodiment includes a network 1630 to which a first SIP server 1601 that is a call control apparatus, a second SIP server 1602, and SIP terminals 1620 and 1621 are connected, and a network 1631 to which the first SIP server 1601, the second SIP server 1602, a third SIP server 1603, and a fourth SIP server 1604 are connected. In the embodiment, the separate networks 1630 and 1631 are described. Alternatively, a single network may be adopted.

The operations of the SIP servers and the SIP terminals according to the embodiment will now be described. An SIP server in a network is congested or is not congested. The case of a congested SIP server according to the embodiment will be described.

(1) The SIP terminal 1620 sends a first SIP request to the first SIP server 1601. The first SIP server 1601 is registered in the SIP terminal 1620 as a destination to which an SIP request is sent.

(2) The first SIP server 1601 receives the first SIP request and reads information on the congestion of calls from a congestion database (DB) 131. The first SIP server 1601 determines whether a value indicated by the information on the congestion exceeds a predetermined threshold value. When the value indicated by the information on the congestion exceeds the predetermined threshold value, the first SIP server 1601 determines that the communication lines are congested. On the other hand, when the value indicated by the information on the congestion does not exceed the predetermined threshold value, the first SIP server 1601 determines that the communication lines are not congested.

The first SIP server 1601, which is assumed to be a congested call control apparatus, reads individual pieces of information on congestion from a congestion DB 132 of the second SIP server 1602, a congestion DB 133 of the third SIP server 1603, and a congestion DB 134 of the fourth SIP server 1604. Then, the first SIP server 1601 selects an SIP server that is not congested on the basis of the read individual pieces of information on congestion and predetermined conditions. In the present embodiment, the first SIP server 1601 selects the second SIP server 1602 as an SIP server that is not congested.

(3) The first SIP server 1601 transfers subscriber information stored in a subscriber DB 171 to the second SIP server 1602. The subscriber information is connection information for controlling a call connection corresponding to the first SIP request received by the first SIP server 1601. The subscriber information transferred from the first SIP server 1601 is stored in a subscriber DB 172.

(4) The first SIP server 1601 sends an SIP response to the SIP terminal 1620, which has sent the first SIP request to the first SIP server 1601. The SIP response indicates that the destination of an SIP request for calling has been changed to the second SIP server 1602. Moreover, the SIP response includes an SIP-Uniform Resource Identifier (URI) that is information for identifying the IP address of the second SIP server 1602 or a communication partner. A URI is a type of representation of the place of an information resource that exists in the Internet. An IP address is information for identifying a call connecting apparatus.

(5) The SIP terminal 1620 generates a second SIP request for calling equivalent to the first SIP request. Then, the SIP terminal 1620 sends the second SIP request to the second SIP server 1602.

(6) The second SIP server 1602 relays the received second SIP request to the SIP terminal 1621. The SIP terminal 1621 is a receiving terminal. Alternatively, the second SIP server 1602 may send a request equivalent to the received second SIP request to the SIP terminal 1621.

(7) The SIP terminal 1621 sends an SIP response corresponding to the second SIP request to the second SIP server 1602. Then, the second SIP server 1602 relays the received SIP response to the originating SIP terminal 1620. Then, the SIP terminal 1620 and the SIP terminal 1621 transport voice to each other without the intervention of the second SIP server 1602 using RTP.

The aforementioned operations in steps (2) to (5) are call connection control according to the present embodiment. The embodiment will now be described in detail.

### 1.1 A Hardware Block Diagram of an SIP Server

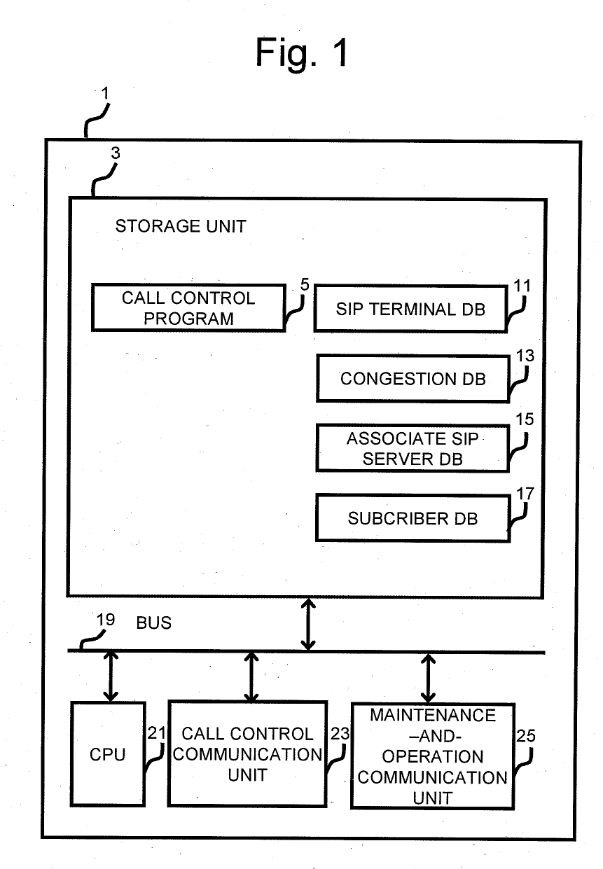

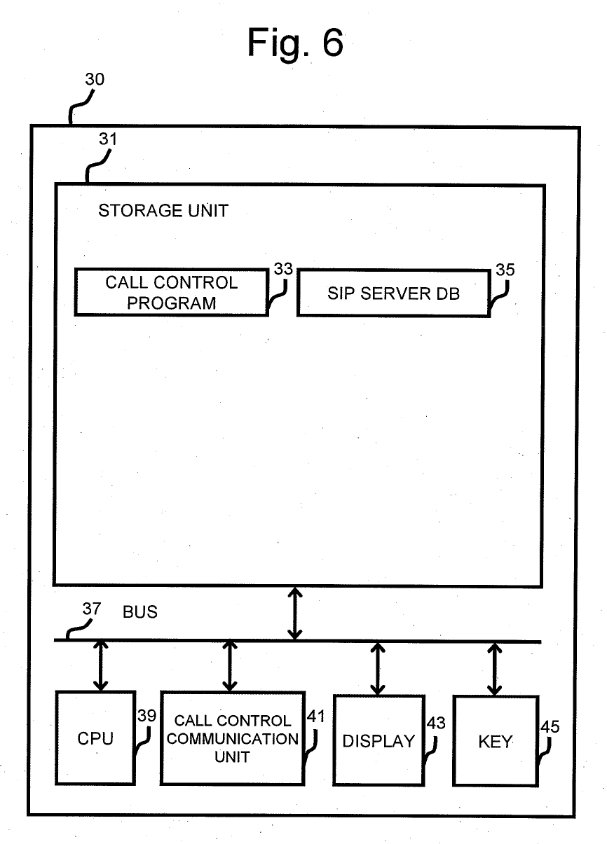

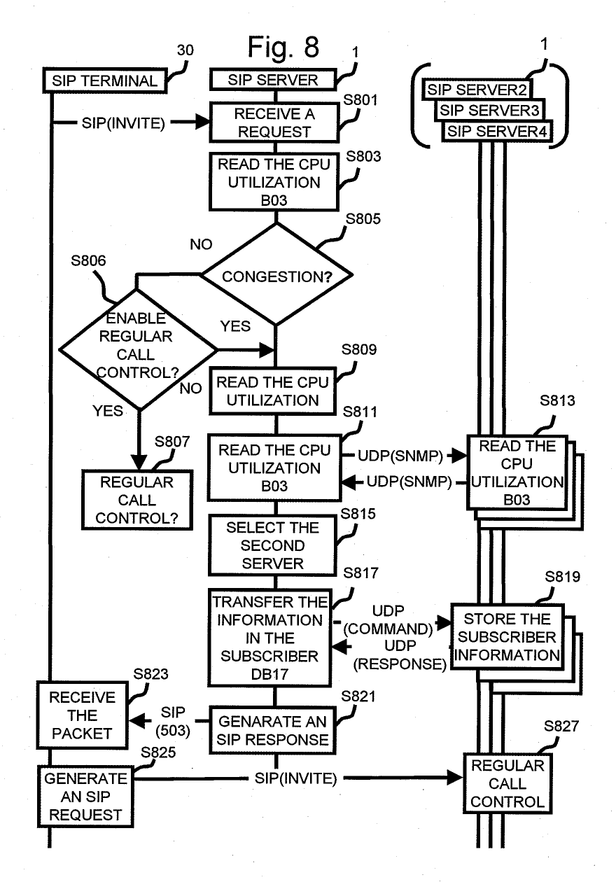

SIP servers 1 shown in FIG. 1 are equivalent to the first SIP server 1601, the second SIP server 1602, the third SIP server 1603, and the fourth SIP server 1604 shown in FIG. 16. Each of the SIP servers 1 includes a storage unit 3, a bus 19, a central processing unit (CPU) 21, a call control communication unit 23, and a maintenance-and-operation communication unit 25. The storage unit 3 stores a call control program 5, an SIP terminal DB 11, a congestion DB 13, an associate SIP server DB 15, and a subscriber DB 17. The bus 19 is a bus for exchanging information among the storage unit 3, the CPU 21, the call control communication unit 23, and the maintenance-and-operation communication unit 25. The CPU 21 executes the call control program 5 for controlling the operation of each of the SIP servers 1 described in FIG. 8. The call control communication unit 23 performs communication related to control of calls between each of the SIP servers 1 and an SIP terminal 30 described in FIG. 6 or an associate one of the SIP servers 1. The maintenance-and-operation communication unit 25 performs communication related to inquiries on the congestion conditions of calls, transfer of subscriber information, and the like between each of the SIP servers 1 and an associate one of the SIP servers 1.

### 1.2 The Layout of an SIP Terminal DB

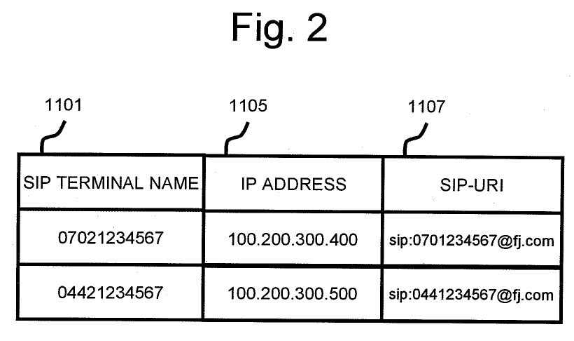

FIG. 2 shows the SIP terminal DB 11, which stores information on SIP terminals registered by each of the SIP servers 1 as objects for which call connections are to be established. Each of the SIP servers 1 sets information on an SIP terminal upon receiving an SIP request for registration from the SIP terminal. Each entry in the SIP terminal DB 11 includes an SIP terminal name 1101, an IP address 1105, and an SIP-URI 1107. The SIP terminal name 1101 is information used by each of the SIP servers 1 to identify an SIP terminal that is a communication partner. The IP address 1105 is information used by each of the SIP servers 1 as a destination to which a packet is sent. The SIP-URI 1107 is information used by each of the SIP servers 1 to identify an SIP terminal that is a communication partner.

### 1.3 The Layout of a Congestion DB

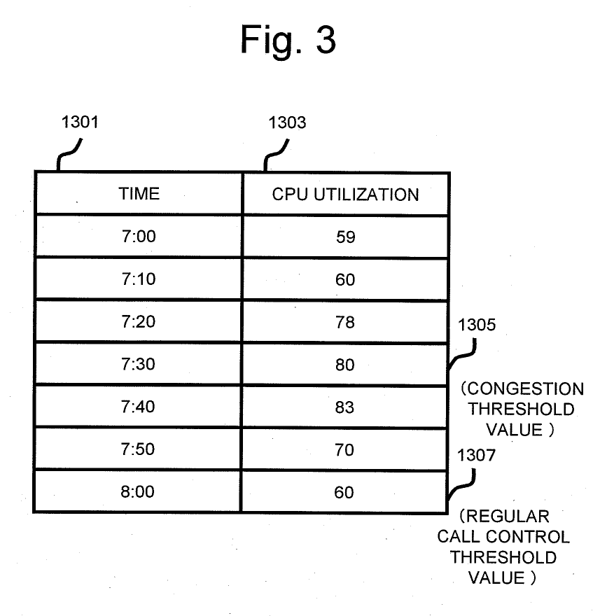

FIG. 3 shows the congestion DB 13. The congestion DB 13 is equivalent to the congestion DB 131, the congestion DB 132, the congestion DB 133, and the congestion DB 134 shown in FIG. 16 and stores the congestion conditions of calls in each of the SIP servers 1. The congestion DB 13 is used to determine whether each of the SIP servers 1 can control a new call connection. The congestion conditions of calls here represent conditions in which the CPU 21 cannot control a new call connection because the CPU 21 is occupied by, for example, the concentration of call connections, or backing up of or inquiries in the individual DBs held by each of the SIP servers 1. The main factor of the occupation of the CPU 21 is the concentration of call connections, and thus it can be that the degree of occupation of the CPU 21 is proportional to the degree of concentration of call connections. Thus, in the present embodiment, a CPU utilization 1303 that indicates the occupation of the CPU 21 and time 1301 when the CPU utilization 1303 was collected are stored in each entry in the congestion DB 13. The CPU utilization 1303 is collected using a system status collection command provided in the SIP servers 1. The time 1301 can be freely set by an administrator of each of the SIP servers 1. Moreover, the congestion DB 13 is associated with an Object Identifier (OID) that is identification information for reading the CPU utilization 1303. An associate one of the SIP servers 1 reads the CPU utilization 1303 using the OID.

Moreover, in the present embodiment, a CPU utilization of 80% is defined as a congestion threshold value 1305 that means a status in which corresponding one of the SIP servers 1 accepts ten or more calls per second via the call control communication unit 23, so that, although the CPU 21 can control communication via the maintenance-and-operation communication unit 25, the CPU 21 cannot control a new call connection via the call control communication unit 23. A CPU utilization of 60% is defined as a regular call control threshold value 1307 that means a status in which corresponding one of the SIP servers 1 accepts six or more calls per second via the call control communication unit 23, so that the CPU 21 can control communication via the maintenance-and-operation communication unit 25 and a new call connection via the call control communication unit 23, i.e., a status in which congestion call control can be returned to regular call control.

### 1.4 The Layout of an Associate SIP Server DB

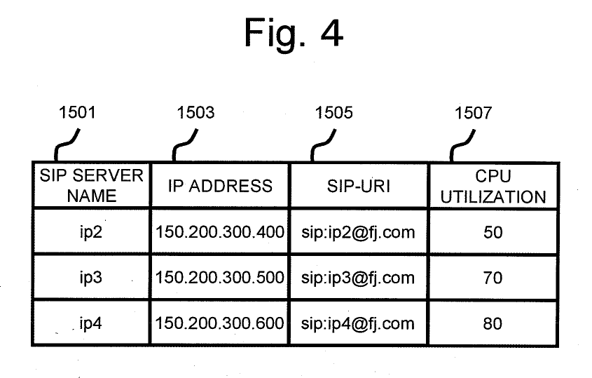

FIG. 4 shows the associate SIP server DB 15. The associate SIP server DB 15 is equivalent to the congestion DB 131, the congestion DB 132, the congestion DB 133, and the congestion DB 134 shown in FIG. 16 and stores information used by each of the SIP servers 1 to obtain the congestion conditions of associate ones of the SIP servers 1. Each entry in the associate SIP server DB 15 includes an SIP server name 1501, an IP address 1503, an SIP-URI 1505, and a CPU utilization 1507. The SIP server name 1501 is information used by each of the SIP servers 1 to identify an associate SIP server that is a communication partner. The IP address 1503 is information used by each of the SIP servers 1 as a destination to which a packet is sent. The SIP-URI 1505 is information used by each of the SIP servers 1 to identify an associate SIP server that is a communication partner. The CPU utilization 1507 represents the CPU utilization of corresponding associate one of the SIP servers 1. The CPU utilization 1507 is equivalent to the CPU utilization 1303. The SIP server name 1501, the IP address 1503, and the SIP-URI 1505 are freely set by an administrator of each of the SIP servers 1. The CPU utilization 1507 is the CPU utilization 1303 of corresponding associate one of the SIP servers 1 that is read and stored upon setting by an administrator of each of the SIP servers 1.

### 1.5 The Layout of a Subscriber DB

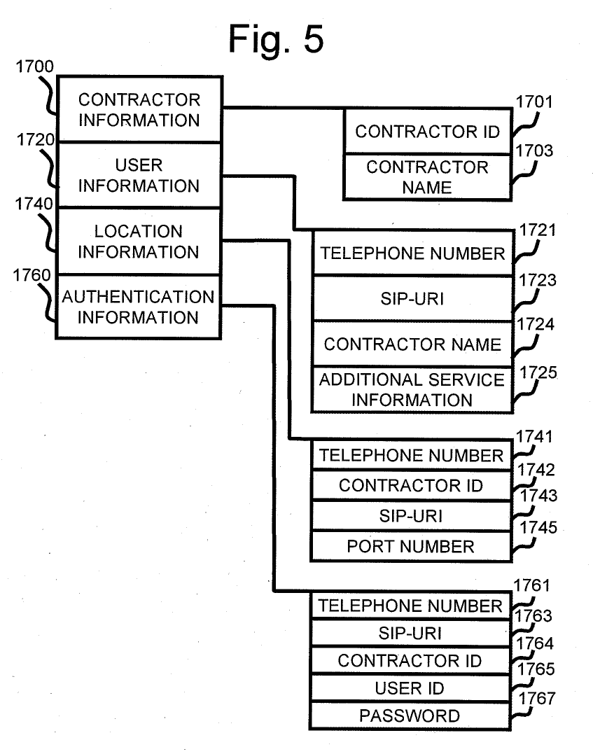

FIG. 5 shows the subscriber DB 17. The subscriber DB 17 is equivalent to the subscriber DB 171 and the subscriber DB 172 shown in FIG. 16 and stores subscriber information that is used by each of the SIP servers 1 to process call connection requests received from SIP terminals registered as objects for which call connections are to be established. Each entry in the subscriber DB 17 includes contractor information 1700, user information 1720, location information 1740, and authentication information 1760. The contractor information 1700 includes a contractor identification (ID) 1701 and a contractor name 1703. The contractor ID 1701 is information used by each of the SIP servers 1 to identify a contractor without using a contractor name. The contractor name 1703 is used by each of the SIP servers 1 to check the name of a person under a contract for call connection service. The user information 1720 includes a telephone number 1721, an SIP-URI 1723, a contractor ID 1724, and additional service information 1725. The telephone number 1721 is used by each of the SIP servers 1 to identify a contractor who is receiving call connection service. The SIP-URI 1723 is used by each of the SIP servers 1 to identify an SIP terminal that is a communication partner. Moreover, the SIP-URI 1723 is used by each of the SIP servers 1 to identify a contractor who is receiving call connection service. The SIP-URI 1723 can be used in the same manner as the telephone number 1721 by setting the telephone number 1721 as a part preceding @ of the SIP-URI 1723. The additional service information 1725 is used by each of the SIP servers 1 to manipulate information on types of additional service for which a corresponding subscriber made a contract. Information on types of additional service includes, for example, information on whether a contract for originating number notification exists. The location information 1740 includes a telephone number 1741, a contractor ID 1742, an SIP-URI 1743, and a port number 1745. The telephone number 1741, the contractor ID 1742, and the SIP-URI 1743 are equivalent to the telephone number 1721, the contractor ID 1724, and the SIP-URI 1723, respectively. The port number 1745 represents a sub-address provided within an IP address used by each of the SIP servers 1 as a destination to which a packet is sent. The authentication information 1760 includes a telephone number 1761, an SIP-URI 1763, a contractor ID 1764, a user ID 1765, and a password 1767. The telephone number 1761, the SIP-URI 1763, and the contractor ID 1764 are equivalent to the telephone number 1721, the SIP-URI 1723, and the contractor ID 1724, respectively. The user ID 1765 is used by each of the SIP servers 1 to verify a user of service who needs to be authenticated. The password 1767 is used by each of the SIP servers 1 to determine whether to permit the use of service that requires authentication.

Basically, the components of the subscriber DB 17 are set by an administrator in advance using a system subscriber information registration command provided in the SIP servers 1. However, when a telephone company that provides IP telephone service partially makes the right for the set-up accessible from contractors, for example, the additional service information 1725, the user ID 1765, and the password 1767 can be set from the SIP terminal 30.

### 2. A Hardware Block Diagram of an SIP Terminal

The SIP terminal 30 shown in FIG. 6 is equivalent to the SIP terminal 1620 and the SIP terminal 1621 shown in FIG. 16. The SIP terminal 30 includes a storage unit 31, a bus 37, a CPU 39, a call control communication unit 41, a display 43, and keys 45. The storage unit 31 stores a call control program 33 and an SIP server DB 35. The bus 37 is a bus for exchanging information among the storage unit 31, the CPU 39, the call control communication unit 41, the display 43, and the keys 45. The CPU 39 executes the call control program 33 for controlling the operation of the SIP terminal 30 described in FIG. 8. The call control communication unit 41 performs communication related to control of calls between the SIP terminal 30 and a corresponding one of the SIP servers 1 described above. The display 43 displays the result of operation related to an IP telephone. The keys 45 are used for an input operation on an IP telephone.

### 2.1 The Layout of an SIP Server DB

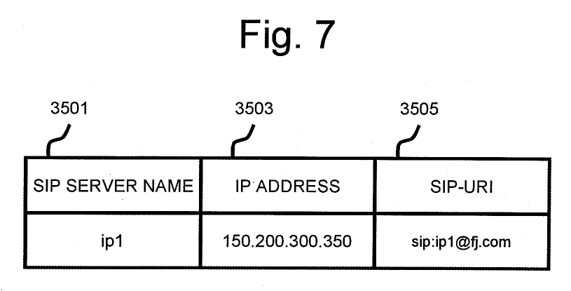

FIG. 7 shows the SIP server DB 35. The SIP server DB 35 stores information on ones of the SIP servers 1 registered by the SIP terminal 30 as objects for which call connections are to be established. Information in the SIP server DB 35 is set by a user in advance. Each entry in the SIP server DB 35 includes an SIP server name 3501, an IP address 3503, and an SIP-URI 3505. The SIP server name 3501 is information used by the SIP terminal 30 to identify a corresponding one of the SIP servers 1 that is a communication partner. The IP address 3503 is information used by the SIP terminal 30 as a destination to which a packet is sent. The SIP-URI 3505 is information used by the SIP terminal 30 to identify a corresponding one of the SIP servers 1 that is a communication partner.

### 3. A Sequence Diagram of an Embodiment of the Present Invention

The embodiment of the present invention, the outline of which is described above with reference to FIG. 16, will now be described in detail with reference to FIGS. 1, 3, 6, 8, 9, 10, 11, 12, 13, 14, and 15. Since FIG. 8 is a sequence diagram of the embodiment of the present invention, the description is mainly based on FIG. 8. The sequence shown in FIG. 8 is implemented via the call control program 5 (hereinafter called P5) executed by the CPU 21 in each of the SIP servers 1 and the call control program 33 (hereinafter called P33) executed by the CPU 39 in the SIP terminal 30.

### 3.1 Receipt of an SIP Request

In this section, an SIP request for a call connection request received by a first SIP server of the SIP servers 1 from the SIP terminal 30 is described. In step S801 in FIG. 8, P5 receives a packet that includes an SIP request for a call connection request from the SIP terminal 30 via the call control communication unit 23.

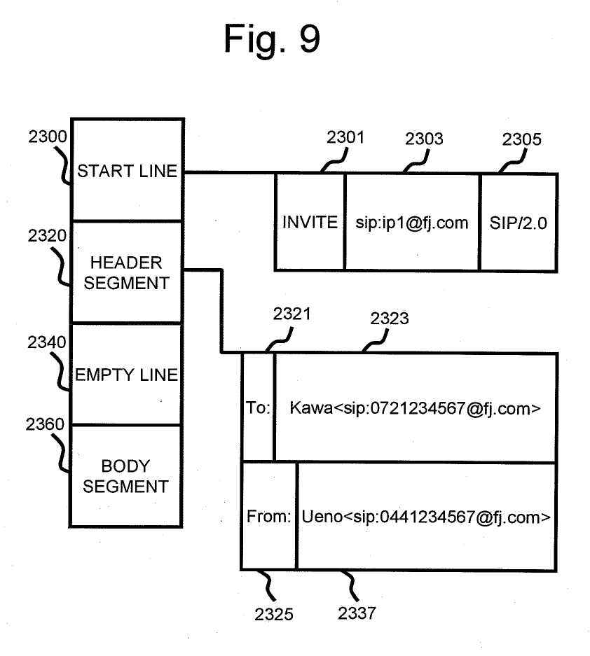

FIG. 9 shows the layout of the SIP request for a call connection request. The SIP request includes a start line 2300, a header segment 2320, an empty line 2340, and a body segment 2360. The start line 2300 includes a method name 2301 that represents the type of the SIP request, a Request-URI 2303 that represents a destination to which the SIP request is sent, and an SIP version 2305. A method INVITE that represents a call connection request is set in the method name 2301. A string “sip:ip1@fj.com” that is the SIP-URI of a corresponding one of the SIP servers 1 is set in the Request-URI 2303. A string “SIP/2.0” is always set in the SIP version 2305. This is because the SIP version 2305 is adopted in a proposal in the early stage of study of SIP and, substantially, need not be considered. The header segment 2320 includes a plurality of types of header. A To header and a From header, out of the plurality of types of header, relate to the present invention. The To header includes information 2321 for identifying the type of the header and an SIP-URI 2323 that represents a destination to which the SIP request is sent. A string “To:” (“:” is a delimiter) is set in the information 2321. A string “sip:0721234567@fj.com” (characters and symbols preceding and succeeding an SIP-URI are modification information) is set in the SIP-URI 2323. The From header includes information 2325 for identifying the type of the header and an SIP-URI 2337 that represents an originating party of the SIP request. A string “From:” (“:” is a delimiter) is set in the information 2325. A string “sip:0441234567@fj.com” (characters and symbols preceding and succeeding an SIP-URI are modification information) is set in the SIP-URI 2337. The empty line 2340 separates the header segment 2320 from the body segment 2360. The body segment 2360 includes information that is not defined in SIP.

### 3.2 Determination of Congestion Conditions

In this section, a process of determining congestion conditions to determine whether the first SIP server can control a new call connection is described. In step S803 in FIG. 8, P5 reads the CPU utilization 1303 in the congestion DB 13. The CPU utilization 1303 is stored in the congestion DB 13 in advance using the system status collection command provided in the SIP servers 1.

In step S805, P5 determines whether the CPU utilization 1303 read in step S803 exceeds the congestion threshold value 1305 of the CPU utilization provided in each of the SIP servers 1 shown in FIG. 3 and congestion conditions have been reached.

### 3.3 Reading of the Congestion Conditions of Associate SIP Servers

In this section, a process of reading the congestion conditions of associate ones of the SIP servers 1 that are used by the first SIP server as information for selecting a destination, described below, to which subscriber information is transferred is described. When it is determined as the result of the determination in step S805 in FIG. 8 that the CPU utilization 1303 does not exceed the congestion threshold value 1305, in step S806, P5 determines whether regular call control can be performed. In this determination, it is determined whether the CPU utilization 1303 exceeds the regular call control threshold value 1307 of the CPU utilization provided in each of the SIP servers 1 shown in FIG. 3. When it is determined as the result of the determination in step S806 that the CPU utilization 1303 does not exceed the regular call control threshold value 1307, in step S807, regular call control is performed. When it is determined that the CPU utilization 1303 exceeds the regular call control threshold value 1307, the process proceeds to step S809. When it is determined as the result of the determination in step S805 that the CPU utilization 1303 exceeds the congestion threshold value 1305, the process proceeds to step S809. In step S809, P5 reads the IP address 1503 from the associate SIP server DB 15.

In step S811 in FIG. 8, P5 reads a CPU utilization held by each of the associate ones of the SIP servers 1 using the corresponding IP address 1503 read in step S809 and an OID, held by the first SIP server, that is identification information for reading the CPU utilization of each of the associate ones of the SIP servers 1. This reading operation is performed through the maintenance-and-operation communication unit 25. Moreover, in this reading operation, User Datagram Protocol (UDP) defined in RFC 768 and Simple Network Management Protocol (SNMP) defined in, for example, RFC 1157 are used. The two protocols are used so that SNMP is applied to data fields of UDP. Then, P5 generates a packet that includes UDP described above and sends the packet to each of the associate ones of the SIP servers 1 identified by the corresponding IP address 1503. Subsequently, a packet that includes a CPU utilization is received from each of the associate ones of the SIP servers 1. The process in step S811 is performed one or more times within the number of IP addresses of associate SIP servers in the associate SIP server DB 15.

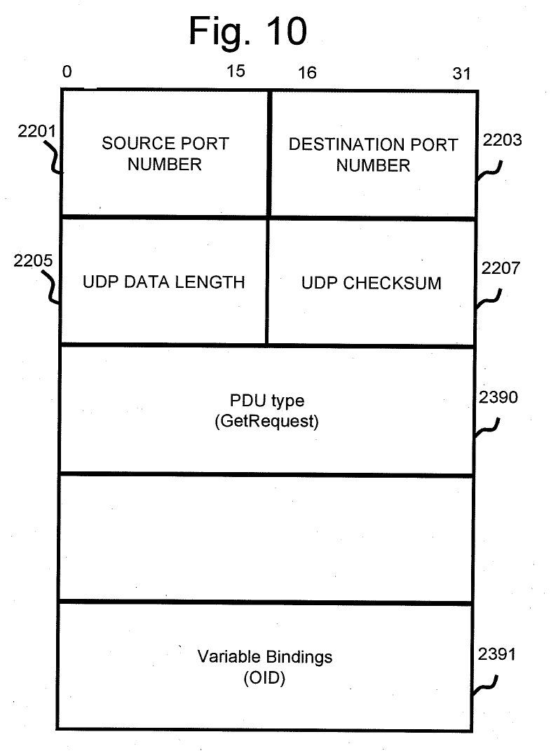

FIG. 10 is the layout of UDP used by the first SIP server to read the CPU utilization of each of the associate ones of the SIP servers 1. The UDP includes a source port number 2201, a destination port number 2203, a UDP data length 2205, a UDP checksum 2207, a protocol data unit (PDU) type 2390, and variable bindings 2391. The PDU type 2390 and the variable bindings 2391 are information in data fields of UDP. A port number from which the corresponding packet is sent is set in the source port number 2201. A port number at which the corresponding packet is received is set in the destination port number 2203. The length of data fields is set in the UDP data length 2205. Information for checking errors is set in the UDP checksum 2207. GetRequest that represents information acquisition is set in the PDU type 2390. An OID is set in the variable bindings 2391.

In step S813, P5 in each of the associate ones of the SIP servers 1 reads the CPU utilization 1303 in the congestion DB 13 using the OID in the received packet, and sends the read CPU utilization 1303 to a party that has sent a request to read the CPU utilization 1303. The UDP is used in this transmission.

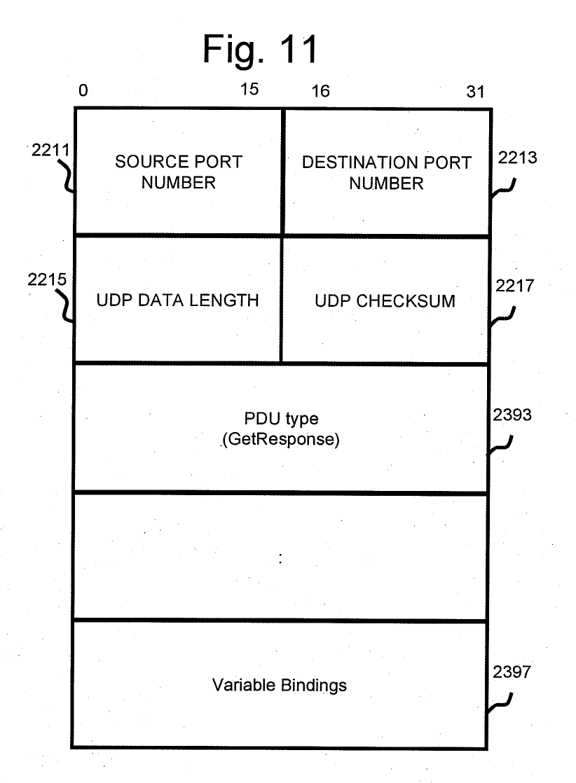

FIG. 11 is the layout of UDP used by each of the associate ones of the SIP servers 1 to send the CPU utilization to the first SIP server. The UDP includes a source port number 2211, a destination port number 2213, a UDP data length 2215, a UDP checksum 2217, a PDU type 2393, and variable bindings 2397. The PDU type 2393 and the variable bindings 2397 are information in data fields of UDP. A port number from which the corresponding packet is sent is set in the source port number 2211. A port number at which the corresponding packet is received is set in the destination port number 2213. The length of data fields is set in the UDP data length 2215. Information for checking errors is set in the UDP checksum 2217. GetResponse that represents a response to information acquisition is set in the PDU type 2393. The CPU utilization 1303 is set in the variable bindings 2397.

### 3.4 Selection of an Associate SIP Server

In this section, a process in which the first SIP server selects a second SIP server of the associate ones of the SIP servers 1 is described. The second SIP server is a destination, described below, to which subscriber information is transferred. In step S815 in FIG. 8, P5 selects the second SIP server, to which information in the subscriber DB 17 corresponding to the SIP request received in step S801 is transferred to perform call control, on the basis of the CPU utilization 1303 received in step S811. Methods for selecting the second SIP server include, for example, a method for selecting an SIP server the CPU utilization 1303 of which is lowest and a method for sequentially or randomly selecting an SIP server from SIP servers the CPU utilization 1303 of each of which does not exceed the congestion threshold value 1305 of the CPU utilization held by the first SIP server.

### 3.5 Transfer of Subscriber Information

In this section, a process in which the first SIP server transfers the subscriber information necessary for a call connection corresponding to the SIP request received in step S801 to the second SIP server is described. In step S817 in FIG. 8, P5 transfers the information in the subscriber DB 17 corresponding to the SIP request received in step S801 to the second SIP server. This transfer operation is performed through the maintenance-and-operation communication unit 25. Moreover, in this transfer operation, UDP is used. A subscriber information registration command is set in a data field of UDP. The subscriber information registration command is used to register the information in the subscriber DB 17 corresponding to the SIP request received in step S801 in the second SIP server. Here, P5 generates a packet that includes UDP described above and then sends the packet to the second SIP server. Subsequently, a packet that includes the result of executing the subscriber information registration command is received from the second SIP server. When the result of executing the subscriber information registration command is normal, the information in the subscriber DB 17 corresponding to the SIP request received in step S801 is deleted.

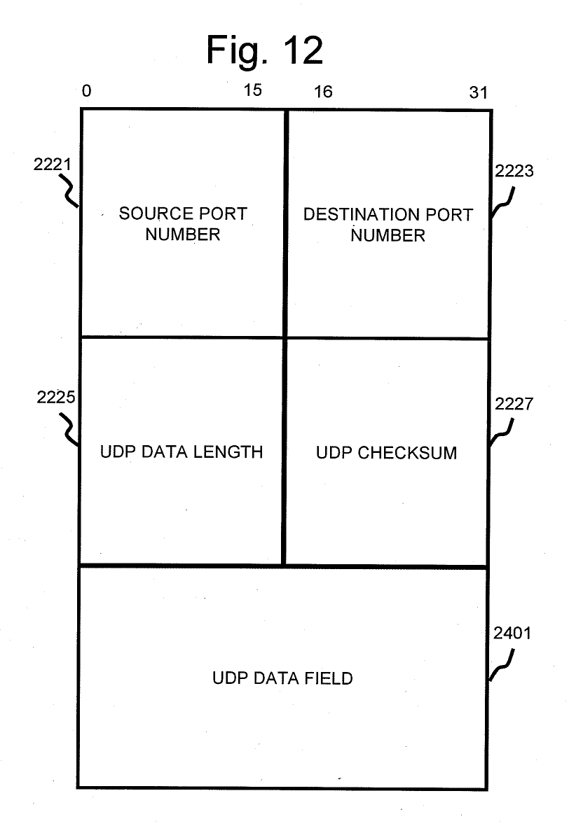

FIG. 12 is the layout of UDP in which the subscriber information registration command is set. The UDP includes a source port number 2221, a destination port number 2223, a UDP data length 2225, a UDP checksum 2227, and a UDP data field 2401. A port number from which the corresponding packet is sent is set in the source port number 2221. A port number at which the corresponding packet is received is set in the destination port number 2223. The length of data fields is set in the UDP data length 2225. Information for checking errors is set in the UDP checksum 2227. The subscriber information registration command is set in the UDP data field 2401.

In step S819 in FIG. 8, P5 in the second SIP server executes the received subscriber information registration command. The subscriber information registration command is that for registering information necessary for a call connection corresponding to the SIP request received in step S801 in the subscriber DB 17. Then, the result of executing the subscriber information registration command is sent to a party that has sent a request to execute the subscriber information registration command. A response from the subscriber information registration command is set in a data field of UDP.

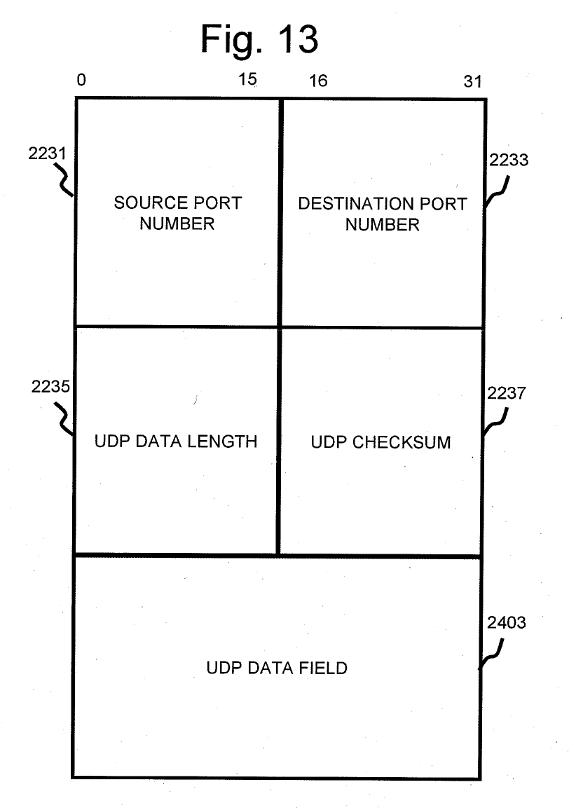

FIG. 13 is the layout of UDP in which an SIP response of the subscriber information registration command is set. The UDP includes a source port number 2231, a destination port number 2233, a UDP data length 2235, a UDP checksum 2237, and a UDP data field 2403. A port number from which the corresponding packet is sent is set in the source port number 2231. A port number at which the corresponding packet is received is set in the destination port number 2233. The length of data fields is set in the UDP data length 2235. Information for checking errors is set in the UDP checksum 2237. The SIP response of the subscriber information registration command is set in the UDP data field 2403.

### 3.6 Generation and Transmission of an SIP Response

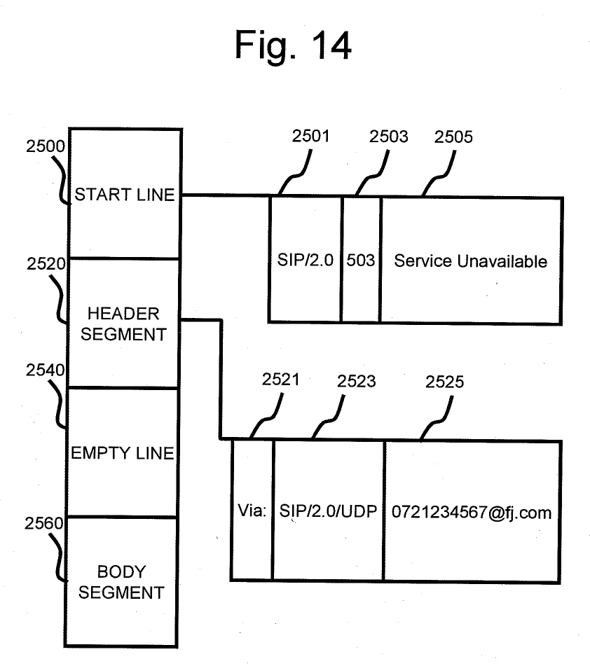

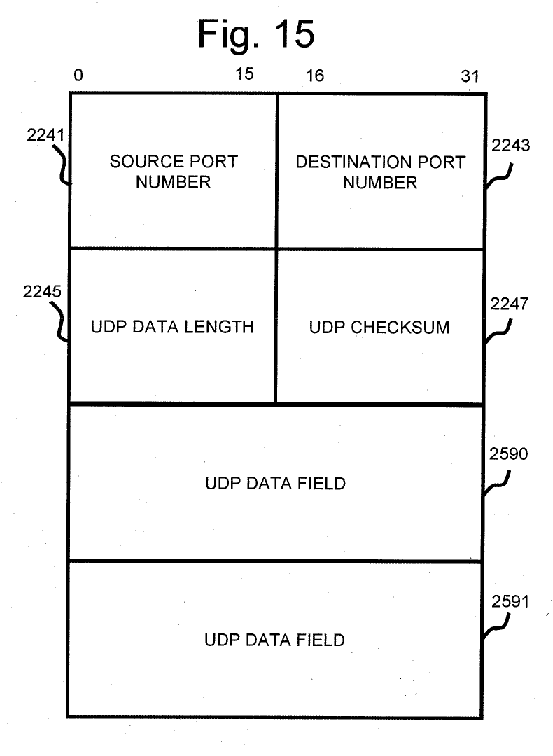

In this section, a process in which the first SIP server sends a notification that the destination, to which the SIP request for a call connection request is sent, has been changed to the SIP terminal 30 is described. When the process in step S817 in FIG. 8 is normally completed, in step S821, P5 generates an SIP response corresponding to the SIP request received in step S801. FIGS. 14 and 15 show information set in the SIP response. Here, P5 generates a packet that includes an SIP response shown in FIG. 14 and UDP shown in FIG. 15 and then sends the packet to an IP address determined by an address 2525 in a Via header shown in FIG. 14 for receiving the SIP response. The packet is sent to the SIP terminal 30 via the call control communication unit 23. This SIP response can be sent even in congestion conditions because the first SIP server is designed so that the first SIP server can process communication with the SIP terminal 30 and the associate ones of the SIP servers 1 with the top priority, and thus the CPU 21 can control the communication even in congestion conditions.

FIG. 14 shows the layout of the SIP response. The SIP response includes a start line 2500, a header segment 2520, an empty line 2540, and a body segment 2560. The start line 2500 includes an SIP version 2501, a status code 2503, and a reason phrase 2505. A string “SIP/2.0” is always set in the SIP version 2501. The reason is the same as that described in the section 3.1 receipt of an SIP Request. The status code 2503 represents the type of the SIP response. A string “503” that means that an SIP request cannot be processed normally because the first SIP server is overloaded is set in the status code 2503. A string “Service Unavailable” that means that an SIP request cannot be processed normally because the first SIP server is overloaded is set in the reason phrase 2505. The header segment 2520 includes a plurality of types of header. A Via header, out of the plurality of types of header, relates to the present invention. The Via header includes information 2521 for identifying the type of the header, a transport layer protocol type 2523 to be used, and the address 2525 for receiving the SIP response. A string “Via:” (“:” is a delimiter) is set in the information 2521. A string “SIP/2.0/UDP” is set in the transport layer protocol type 2523. A string “0721234567@fj.com” is set in the address 2525. The empty line 2540 separates the header segment 2520 from the body segment 2560. The body segment 2560 includes information that is not defined in SIP.

The IP address and SIP-URI of the second SIP server are set in data fields of UDP.

FIG. 15 is the layout of UDP in which the IP address and SIP-URI of the second SIP server are set. The UDP includes a source port number 2241, a destination port number 2243, a UDP data length 2245, a UDP checksum 2247, and UDP data fields 2590 and 2591. A port number from which the corresponding packet is sent is set in the source port number 2241. A port number at which the corresponding packet is received is set in the destination port number 2243. The length of data fields is set in the UDP data length 2245. Information for checking errors is set in the UDP checksum 2247. The IP address of the second SIP server is set in the UDP data field 2590. The SIP-URI of the second SIP server is set in the UDP data field 2591.

### 3.7 Generation and Transmission of an SIP Request

In this section, a process in which the SIP terminal 30 sends an SIP request for a new call connection request to a new transmission destination is described.

In step S823, P33 receives the packet, which includes the SIP response and the UDP from the first SIP server via the call control communication unit 23.

Then, in step S825, P33 generates an SIP request when the status code 2503 in the received SIP response is “503” that means that an SIP request cannot be processed normally because the first SIP server is overloaded. Basically, this SIP request is the same as that received by the first SIP server in step S801. These SIP requests are different from each other in the Request-URI in the start line. In step S823, after the UDP is received, the SIP-URI of the second SIP server set in a data field of the UDP is set as the Request-URI. Then, a packet that includes the generated SIP request and the IP address 2590 of the second SIP server set in a data field of the UDP received in step S823 is generated. Then, the packet is sent to the second SIP server identified by the IP address 2590. This transmission is performed via the call control communication unit 23.

In step S827, the second SIP server receives the packet, which includes the SIP request, from the SIP terminal 30 and then performs regular call control. From then on, the SIP terminal 30 establishes a call connection by sending an SIP request for a call connection request to the second SIP server.

While the present invention has been described on the basis of the embodiment, the present invention is not limited to the aforementioned embodiment and can be embodied in any form without changing an arrangement described in the claims.

What is claimed is:

1. A call control method for controlling a call between an originating terminal and a receiving terminal via a network including a plurality of call control apparatuses, the call control method comprising the steps of:
detecting congestion that disturbs connection of a call between the originating terminal and the receiving terminal by using a call control apparatus requested for a call connection from the originating terminal; and
when congestion is detected for the call connection in the call control apparatus, requesting another call control apparatus in the network to connect the call between the originating terminal and the receiving terminal and notifying the originating terminal to switch from the call control apparatus to the another call control apparatus for executing the call connection.

2. The call control method according to claim 1, wherein the call control apparatus sends connection information to the another call control apparatus for requesting to connect the call between the originating terminal and the receiving terminal, and sends an identification information to the originating terminal for notifying the switch from the call control apparatus to the another call control apparatus for executing the call connection.

3. A call control method for controlling a call between an originating terminal and a receiving terminal via a network, the call control method comprising the steps of:
obtaining connection information from a call control apparatus by which congestion is occurring to disturb connection of a call between the originating terminal and the receiving terminal, the connection information being indicative of a request another call control apparatus in the network to connect the call; and
establishing the call connection between the originating terminal and the receiving terminal on the basis of the connection information.

4. The call control method according to claim 2, wherein the call control apparatus sends the connection information by transmission of a command registered the connection information in the command, and the call control apparatus obtains the connection information by execution of the command.

5. The call control method according to claim 1, wherein the call control apparatus sends the identification information by using a call control communication unit in the call control apparatus, and sends the connection information by using a communication unit in the call control apparatus, other than the call control communication unit.

6. A call control apparatus for controlling a call connection between an originating terminal and a receiving terminal via a network including a plurality of call control apparatuses comprising:
a controller to control the call control apparatus according to a process comprising:
detecting congestion that disturbs connection of a call between the originating terminal and the receiving terminal by using a call control apparatus requested for a call connection from the originating terminal; and
when congestion is detected for the call connection in the call control apparatus, requesting another call control apparatus in the network to connect the call between the originating terminal and the receiving terminal and notifying the originating terminal to switch from the call control apparatus to the another call control apparatus for executing the call connection.

7. The call control apparatus according to claim 6, wherein the call control apparatus sends the connection information by transmission of a command registered the connection information in the command, and the call control apparatus obtains the connection information by execution of the command.

8. The call control apparatus according to claim 6, wherein a call control communication unit in the call control apparatus sends the identification information, and a communication unit in the call control apparatus, other than the call control communication unit, sends the connection information.
